(19) United States
(12) Patent Application Publication
(10) Pub. No.: US 2012/0131562 A1
(43) Pub. Date: May 24, 2012

(54) METHOD AND APPARATUS FOR UPGRADING VIRTUAL MACHINE IN A PORTABLE TERMINAL

(75) Inventor: Hyeon-Ho KIM, Gyeongsangbuk-do (KR)

(73) Assignee: SAMSUNG ELECTRONICS CO., LTD., Gyeonggi-Do (KR)

(21) Appl. No.: 13/302,106

(22) Filed: Nov. 22, 2011

(30) Foreign Application Priority Data
Nov. 22, 2010 (KR) 10-2010-0116503

(51) Int. Cl. G06F 9/45; G06F 9/44

(52) U.S. Cl. 717/148; 717/166

(57) ABSTRACT

A method and apparatus for upgrading a virtual machine in a portable terminal are provided in which an external class file different from a class file defined on a virtual machine for execution of a Java MIDlet is received and stored, then the external class file is dynamically loaded by a class loader when the Java MIDlet is executed. During operation, it is determined whether the external class file is applicable to the virtual machine by analyzing setting information of the external class file, and if so, the external class file is applied to the virtual machine.

### CLAIM OF PRIORITY

This application claims priority under 35 U.S.C. §119(a) to a Korean Patent Application filed in the Korean Intellectual Property Office on Nov. 22, 2010 and assigned Serial No. 10-2010-0116503, the contents of which are incorporated herein by reference.

### BACKGROUND OF THE INVENTION

1. Field of the Invention

The present invention relates to a Java Virtual Machine (JVM) for executing a Java program in a portable terminal.

2. Description of the Related Art

A JVM is embedded into a portable terminal in a fabrication process, for running a Java program related to a mobile system in the portable terminal. Since the JVM resides on a Read Only Memory (ROM) area inaccessible to a user or a service provider, the user must request a modification of the JVM to a portable terminal manufacturer. As the portable terminal manufacturer must configure JVMs according to various service providers or market classification, and maintain and distribute the JVMs exclusively, the user cannot readily use the JVM due to many limitations.

A conventional portable terminal does not interface between a user or a service provider and a JVM. Thus, even though the user wants to create a desired JVM, during running of a Java MIDlet given by a manufacturer, there is no way but to use the provided JVM that provides an operation environment for the Java MIDlet because the user cannot handle the JVM.

### SUMMARY OF THE INVENTION

An aspect of embodiments of the present invention is to address at least the problems and/or disadvantages and to provide at least the advantages described below. Accordingly, an aspect of embodiments of the present invention is to provide a method and apparatus for upgrading a virtual machine that resides on a Read Only Memory (ROM) area that is not easily accessible to a user or a service provider, by using an external class file needed to run a Java program in a portable terminal, so that the virtual machine can be customized for the user.

In accordance with an embodiment of the present invention, there is provided a method for upgrading a virtual machine in a portable terminal, in which an external class file, which is different from a class file defined on a virtual machine for execution of a Java MIDlet, is received and stored, then the external class file is dynamically loaded by a class loader set for execution of the class file when the Java MIDlet is executed. At this time, it is determined whether the external class file is applicable to the virtual machine by analyzing setting information of the external class file, and then the external class file is applied to the virtual machine when is determined that the external class file is applicable to the virtual machine.

In accordance with another embodiment of the present invention, there is provided an apparatus for upgrading a virtual machine in a portable terminal, in which a Java platform has a virtual machine for compiling a Java MIDlet written in Java to a Java byte code, loading and storing a class file needed for execution of the Java MIDlet. receiving an external class file distinguishable from the class file, and applying the external class file, a memory stores the received external class file, and a controller controls reception and storing of the external class file and dynamic loading of the external class file by a class loader, determines whether the external class file is applicable to the virtual machine by analyzing the loaded external class file, and applies the external class file to the virtual machine when is determined that the external class file is applicable to the virtual machine.

### BRIEF DESCRIPTION OF THE DRAWINGS

The above features and advantages of certain embodiments of the present invention will be more apparent from the following detailed description taken in conjunction with the accompanying drawings, in which:

FIG. 1 is a flowchart illustrating a method for upgrading a virtual machine in a portable terminal according to an embodiment of the present invention;

FIG. 2 is a block diagram of an apparatus for upgrading a virtual machine in the portable terminal according to an embodiment of the present invention; and

FIG. 3 illustrates a stack architecture of a Java platform on which a Java Virtual Machine (JVM) is installed, applied to the portable terminal according to the present invention.

Throughout the drawings, the same drawing reference numerals will be understood to refer to the same elements, features and structures.

### DETAILED DESCRIPTION OF THE INVENTION

Reference will now be made in detail to the preferred embodiments of the present invention with reference to the accompanying drawings. Specific details as set forth in the following description are provided to help the understanding of the present invention and it will be understood to those skilled in the art that many modifications can be made to the present invention within the scope and spirit of the present invention, without those specific details.

In accordance with an embodiment of the present invention, while a portable terminal described in the specification is preferably a portable mobile communication terminal, the term “portable terminal” covers a broad range of terminals including information communication devices, multimedia devices, and their applications such as a digital broadcast terminal, a Personal Digital Assistant (PDA), a smart phone, and a 3^{rd} Generation (3G) terminal (e.g. an International Mobile Telecommunication 2000 (IMT-2000) terminal, a Wideband Code Division Multiple Access (WCDMA) terminal, a Global System for Mobile communications/General Packet Radio Service (GSM/GPRS) terminal, and a Universal Mobile Telecommunication Service (UMTS) terminal). Thus, the teachings of the present invention described herein will be applicable to the above mentioned terminals.

Before describing the present invention in detail, it is clarified that an application refers to any application program stored and executed in a portable terminal, particularly to a Java MIDlet in the embodiment of the present invention.

Briefly, the present invention is intended to upgrade a virtual machine using a class file required to execute a Java application that runs on the virtual machine of a portable terminal. More particularly, the present invention provides a method for efficiently extending a virtual machine that resides on a Read Only Memory (ROM) area that is not traditionally easily accessible to a user or a service provider. This is achieved by minimizing time taken to upgrade the overall virtual machine in a portable terminal. In operation, when the user or service provider wants to add a function to or modify a function in the virtual machine or to change a User Interface (UI) regarding the virtual machine, a changed or external class file is received from a server or the user and stored in an area other than a permanent class area of the virtual machine. Note that the external class file refers to a class file that is user-defined or customized to define a class library. In the embodiment, the stored class file is newly added to the virtual machine or an existing class file is modified to the stored class file in the virtual machine depending on whether setting information of the stored class file is applicable to the virtual machine.

Thereafter, if the class file is invoked during executing the Java application, the class is dynamically read by loading the external class file first. In this manner, the external class file desired by the user or the service provider is added or a modification is made to an existing class file to be updated as the external class file in the virtual machine of the portable terminal, thus minimizing the upgrade time of the virtual machine.

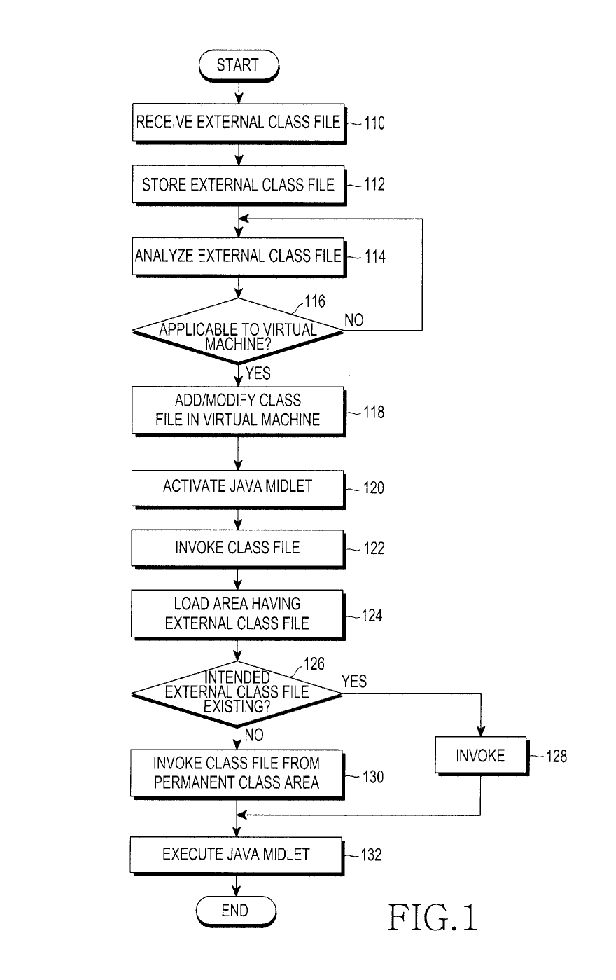

Now, a description will be given of a method for upgrading a virtual machine in a portable terminal according to an embodiment of the present invention with reference to FIG. 1.

FIG. 1 is a flowchart illustrating a method for upgrading a virtual machine in a portable terminal according to an embodiment of the present invention.

Referring to FIG. 1, an external class file distinguished from a class file required to run a Java MIDlet and defined on a virtual machine is received in step 110.

The virtual machine specifies an environment in which a Java byte code is executed. The Java byte code is created by compiling Java. A Java Virtual Machine (JVM) is based on a Java platform in the embodiment of the present invention. To execute a Java program compiled to a Java byte code, a user uses the JVM. This JVM includes a class area in which class files needed to execute Java MIDlets are loaded and stored, and the class area is a permanent area installed by a Java platform developer in an initial stage of fabrication of the portable terminal.

The virtual machine applied to the embodiment of the present invention may be one of a JVM or a Kilo Virtual Machine (KVM).

The received external class file, which is received from the external, refers to a class file that defines a class library, and is user-customized and flexibly includes authorization setting information within a system.

A Java MIDlet, one of various service applications provided to a portable terminal by a Content Provider (CP), generically refers to an application written in conformance with the Mobile Information Device Profile (MIDP) standard. The Java

MIDlet is a component of a Java2 Micro Edition (J2ME) execution environment, designed so as to run in the portable mobile terminal. According to the embodiment of the present invention, the Java MIDlet is run and controlled by the virtual machine.

In step 112, the received external class file is stored in an area other than the permanent class area designated for storing class files in the virtual machine. This step is performed by a class loader that is capable of loading the permanent class area having class files so that the virtual machine can execute a class.

Specifically, if the virtual machine starts, at the moment a class file is referred to by a Java MIDlet, all class files are dynamically linked to the virtual machine. The class loader dynamically reads the class file from the permanent class area. Before this operation, the class loader first loads the area in which the externally received changed class file is kept to thereby determine the presence or absence of the changed class file.

Setting information of the stored external class file is analyzed in step 114 and it is determined whether the external class file is applicable to the virtual machine in step 116. That is, it is determined whether the setting information of the external class file matches to the version of the virtual machine and a pre-defined class file type, attribute, and access control rule.

If it is determined that the external class file is applicable to the virtual machine, the external class file is added to or an existing class file is modified to the external class file in the virtual machine in step 118.

More specifically, in the presence of a class file corresponding to the external class file, the external class file is applied as a modification to the existing class file. In the absence of the class file corresponding to the external class file, the external class file is added as a new class file to the virtual machine. In this manner, the overall virtual machine is upgraded.

In step 120, the Java MIDlet is activated by the user. Then, a class file for the Java MIDlet is invoked in step 122.

In step 124, the area in which an external class file is kept is first loaded by the class loader.

It is determined whether the external class file is present in step 126. In the presence of the external class file, the external class file is invoked for execution in step 128. On the other hand, in the absence of the external class file, a class file is invoked from the permanent class area in step 130 and the Java MIDlet is executed with the class file in step 132.

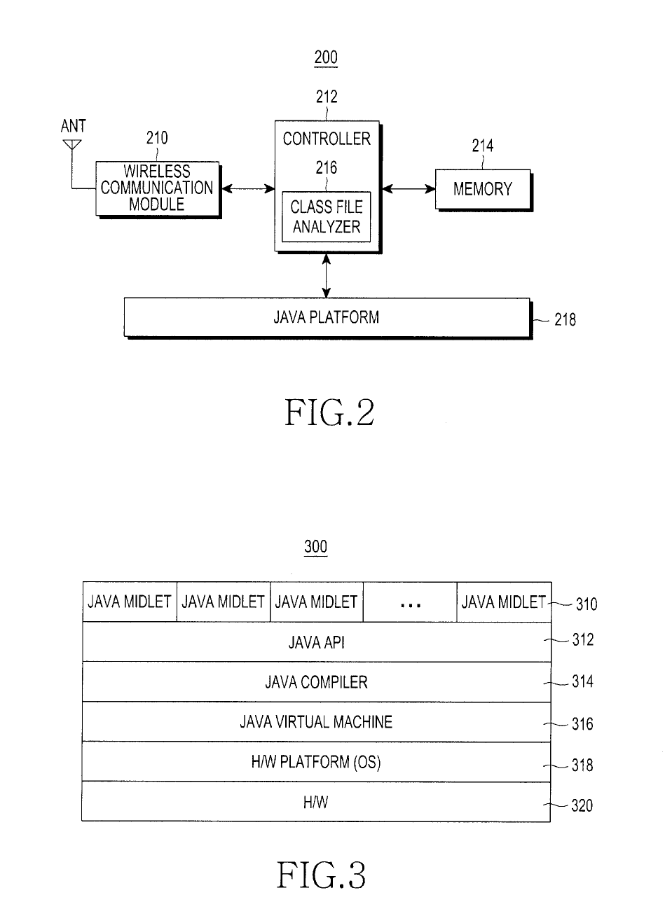

With reference to FIG. 2, an apparatus for upgrading a virtual machine in a portable terminal according to an embodiment of the present invention will be described below.

FIG. 2 is a block diagram of an apparatus for upgrading a virtual machine in a portable terminal according to an embodiment of the present invention.

Referring to FIG. 2, a virtual machine upgrade apparatus 200 for the portable terminal includes a wireless communication module 210, a controller 212, a memory 214, and a Java platform 218.

The wireless communication module 210 receives a downlink radio signal in the air through an antenna and provides downlink data acquired by demodulating the downlink radio signal to the controller 212. The wireless communication module 210 also generates an uplink radio signal by modulating uplink data received from the controller 212 and transmits the uplink radio signal in the air through the antenna. The modulation and demodulation may be performed in Frequency Division Multiplexing (FDM) or Time Division Multiplexing (TDM), herein preferably in Code Division Multiple access (CDMA).

The wireless communication module 210 receives an external changed class file.

The memory 214 stores information selected according to user selection and user information.

The memory 214 may store programs needed for processing and controlling of the controller 212 and temporarily store input and output data (e.g. a phonebook, messages, a media player, a net book, etc.). The memory 214 may also store a received external class file. The class loader of the virtual machine can access the memory 214.

The Java platform 218 compiles a Java MIDlet written in Java to a Java byte code, loads a class file needed to execute the Java MIDlet, stores the loaded class file, and receives and applies an external class file distinguished from the class file.

FIG. 3 illustrates a stack architecture of a Java platform 300 on which a JVM is installed, applied to the portable terminal according to the present invention.

Referring to FIG. 3, a hardware platform (Operating System (OS) 318 resides at the lowest layer of the Java platform 300 for controlling a CPU, a memory, and registers.

A JVM 316 is located above the hardware platform (OS) 318. The JVM 316 interprets a byte code needed to execute a Java program and enables execution of a Java code irrespective of a loaded OS.

A Java compiler 314 is above the JVM 316. A Java program written in Java is compiled to a Java byte code by the Java compiler 314 and interpreted by the JVM 316, for execution.

There are a Java Application Program Interface (API) 312 and Java MIDlets 310 above the Java compiler 314.

Referring to FIG. 2 again, in the virtual machine upgrade apparatus 200 of the portable terminal, the controller 212 provides overall control to the portable terminal and controls signal flows between internal blocks. In addition, the controller 212 controls reception and storing of an external class file distinguished from class files needed to execute Java MIDlets, controls the class loader to dynamically load the stored external class file, analyzes the external class file, determines whether the external class file is applicable to the virtual machine, and applies the external class file if the external class file is applicable to the virtual machine. A class file analyzer 216 of the controller 212 is responsible for analyzing the external class file. The class file analyzer 216 analyzes whether setting information of the external class file matches the version of the JVM and a predefined class file type, attribute, and access control rule, under the control of the controller 212.

When a class file is invoked for a Java MIDlet, the controller 212 controls the class loader to first load the area in which a received external class file is stored. In the presence of an external class file, the controller 212 invokes the external class file. On the other hand, in the absence of an external class file, the controller 212 invokes a class file from the permanent class area of the virtual machine.

As is apparent from the above description of the present invention, a specific class file desired by a user or a service provider is added to a virtual machine of a portable terminal or an existing class file is modified to the specific class file in the virtual machine, through analyzing an externally received class file. Therefore, the overall virtual machine can be upgraded in a minimized time in the portable terminal, thereby efficiently extending the virtual machine.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the present invention has been particularly shown and described with reference to embodiments thereof, it will be understood by those of ordinary skill in the art that various changes in form and details may be made therein without departing from the spirit and scope of the present invention as defined by the following claims.

What is claimed is:

1. A method for upgrading a virtual machine in a portable terminal, comprising:
storing an external class file distinguished from a class file defined on a virtual machine for execution of a Java MIDlet;
dynamically loading the external class file by a class loader when the Java MIDlet is executed;
determining whether the external class file is applicable to the virtual machine by analyzing setting information of the external class file; and
applying the external class file to the virtual machine when it is determined that the external class file is applicable to the virtual machine.

2. The method of claim 1, wherein the storing of the received external class file comprises storing the received external class file in an area other than a permanent class area designated for storing the class file in the virtual machine.

3. The method of claim 1, further comprising:
loading an area in which the external class file is stored first, by the class loader, when the Java MIDlet invokes the class file in the virtual machine;
invoking the external class file in the presence of the external class file in the area; and
invoking the class file needed execution of the Java MIDlet from a permanent class area in the absence of the external class file in the area.

4. The method of claim 1, wherein the analyzing step comprises analyzing whether the setting information of the external class file matches a version of the virtual machine, a predefined class file type, a predefined attribute, and a predefined access control rule.

5. The method of claim 1, wherein the external class file defines a class library, which is customized by a user, and flexibly includes authorization setting information within a system.

6. The method of claim 1, wherein the virtual machine is one of a Java Virtual Machine (JVM) and a Kilo Virtual Machine (KVM).

7. The method of claim 1, wherein each of the class files is commonly sharable between one or more Java MIDlets compiled to Java byte codes for execution of the one or more Java MIDlets.

8. The method of claim 1, wherein the applying step comprises adding the external class file to the virtual machine or modifying the class file with the external class file in the virtual machine.

9. An apparatus for upgrading a virtual machine in a portable terminal, comprising:
a Java platform having a virtual machine for compiling a Java MIDlet written in Java to a Java byte code, loading and storing a class file needed for execution of the Java MIDlet, receiving an external class file;
a memory for storing the received external class file; and
a controller for controlling the storage of the external class file and dynamic loading of the external class file by a class loader, determining whether the external class file is applicable to the virtual machine by analyzing the loaded external class file, and applying the external class file to the virtual machine when is determined that the external class file is applicable to the virtual machine.

10. The apparatus of claim 9, wherein if the Java MIDlet invokes a class file in the virtual machine, the controller controls the class loader first to load an area in which the external class file is stored, invokes the external class file in the presence of the external class file in the area, and invokes the class file needed execution of the Java MIDlet from a permanent class area in the absence of the external class file in the area.

11. The apparatus of claim 9, wherein the controller comprises a class file analyzer for analyzing whether setting information of the external class file matches a version of the virtual machine, a predefined class file type, a predefined attribute, and a predefined access control rule.

12. The apparatus of claim 9, wherein the external class file defines a class library, which is customized by a user, and flexibly includes authorization setting information within a system.
